(19) United States
(12) Patent Application Publication
(10) Pub. No.: US 2019/0149423 A1
(43) Pub. Date: May 16, 2019

(54) STORAGE APPARATUS, STORAGE SYSTEM, AND STORAGE APPARATUS MANAGEMENT METHOD

(71) Applicant: HITACHI, LTD., Tokyo (JP)

(72) Inventors: Keisuke OKAMURA, Tokyo (JP); Wataru OKADA, Tokyo (JP)

(73) Assignee: HITACHI, LTD., Tokyo (JP)

(21) Appl. No.: 16/121,029

(22) Filed: Sep. 4, 2018

(30) Foreign Application Priority Data
Nov. 13, 2017 (JP) 2017-218345

(51) Int. Cl. H04L 12/24

(52) U.S. Cl. CPC H04L 41/12

(57) ABSTRACT

The storage apparatus includes a control unit that manages a storage area allocated to the host computer. The control unit assigns an identifier to the host computer that accesses the storage area, and assigns the identifier to the first computer's first interface that accesses the storage area, assigns a second port identifier of a second interface of a storage device that communicates with a host computer to a first port identifier of the first interface by accepting a port identifier and sets a logical path, storing the port identifier and the second port identifier in association with each other in the host computer connection information, assigning the identifier of the storage area to the identifier of the host computer, associating the identifier of the storage computer with the identifier of the host computer, and storing the storage area allocation information.

### CLAIM OF PRIORITY

The present application claims priority from Japanese patent application JP 2017-218345 filed on Nov. 13, 2017, the content of which is hereby incorporated by reference into this application.

### BACKGROUND

The present invention relates to a technique to manage an access path. In a storage system in which a port (hereinafter HBA port) of an HBA (Host Bus Adapter) of a host computer and a storage apparatus port are connected via a SAN (Storage Area Network), a zoning technique has been known to control a volume (LU: Logical Unit) allowed by a storage apparatus to be accessed by a host computer (see for example Patent Publication 1). Patent Publication 1 discloses that each port of the storage apparatus has a list set for access-allowed HBA ports and access-allowed LUs for each HBA port.

### PATENT PUBLICATION

### (Patent Publication 1) Japanese Patent No. 4698316

### SUMMARY

In the above conventional example, a storage system manager must set a list of HBA ports and LUs for the respective ports of the storage apparatus based on the zoning policy, causing a complicated setting. Furthermore, when the storage system needs a configuration change (e.g., a change in LU), the manager must detect all zoning policies for which the applicable HBA ports are set and must appropriately edit all of the applicable zoning policies, which requires a huge labor.

Furthermore, the only thing the storage system can know about the transmission destination is HBA ports. Thus, the storage system cannot know whether a path is accessed that has sufficient redundancy for a host computer. Thus, the manager must carefully set the zoning policy based on the relation between the host computer and the HBA ports, thus requiring a complicated setting.

In view of the above disadvantages, it is an objective of the present invention to reduce the labor required to manage the access path while assuring the access control for the storage apparatus.

A representative aspect of the present disclosure is as follows. A storage apparatus including a processor, a memory, and a storage medium, comprising: a control unit for managing a storage area allocated from the storage medium to a host computer, wherein the control unit is configured: to give an identifier to a host computer accessing the storage area, to receive a first port identifier of a first interface of the host computer accessing the storage area, to allocate, to the first port identifier of the first interface, a second port identifier of a second interface of the storage apparatus communicating with the host computer to set a logical path to associate the identifier of the host computer with the first port identifier and the second port identifier to store the identifier of the host computer in host computer connection information, to allocate the identifier of the storage area to the identifier of the host computer to associate the identifier of the host computer with the identifier of the storage area to store the identifier of the host computer in storage area allocation information, and to refer, upon receiving an access to the storage area from the host computer, to the host computer connection information and the storage area allocation information to control the access.

Thus, according to the present invention, the labor for the management of the access path can be reduced while assuring the access control for the storage apparatus.

### BRIEF DESCRIPTION OF THE DRAWINGS

FIG. 1 is a block diagram illustrating one example of the storage system according to an embodiment of this invention.

FIG. 2 is a block diagram illustrating one example of the storage apparatus according to the embodiment of this invention.

FIG. 3 is a block diagram illustrating one example of the management computer according to the embodiment of this invention.

FIG. 4 is a block diagram illustrating one example of the host computer according to the embodiment of this invention.

FIG. 5 illustrates one example of the host computer connection information table according to the embodiment of this invention.

FIG. 6 illustrates one example of the LU allocation table according to the embodiment of this invention.

FIG. 7 is a flowchart illustrating one example of the processing to register the host computer according to the embodiment of this invention.

FIG. 8 is a flowchart illustrating one example of the processing to allocate the HBA port of the host computer according to the embodiment of this invention.

FIG. 9 is a flowchart illustrating one example of the processing to allocate the new LU to the host computer according to the embodiment of this invention.

FIG. 10 is a flowchart illustrating one example of the processing performed by the access control program according to the embodiment of this invention.

FIG. 11 illustrates one example of the physical path connection information table according to the embodiment of this invention.

FIG. 12 is a flowchart illustrating one example of the processing performed in the port status search program according to the embodiment of this invention.

FIG. 13 illustrates one example of the priority setting table according to the embodiment of this invention.

FIG. 14 is the former half of flowchart showing one example of the processing to suggest the port allocation according to the embodiment of this invention.

FIG. 15 is the latter half of flowchart showing one example of the processing to suggest the port allocation according to the embodiment of this invention.

### DETAILED DESCRIPTION OF THE PREFERRED EMBODIMENTS

Below, embodiments of the present invention will be explained with reference to affixed drawings.

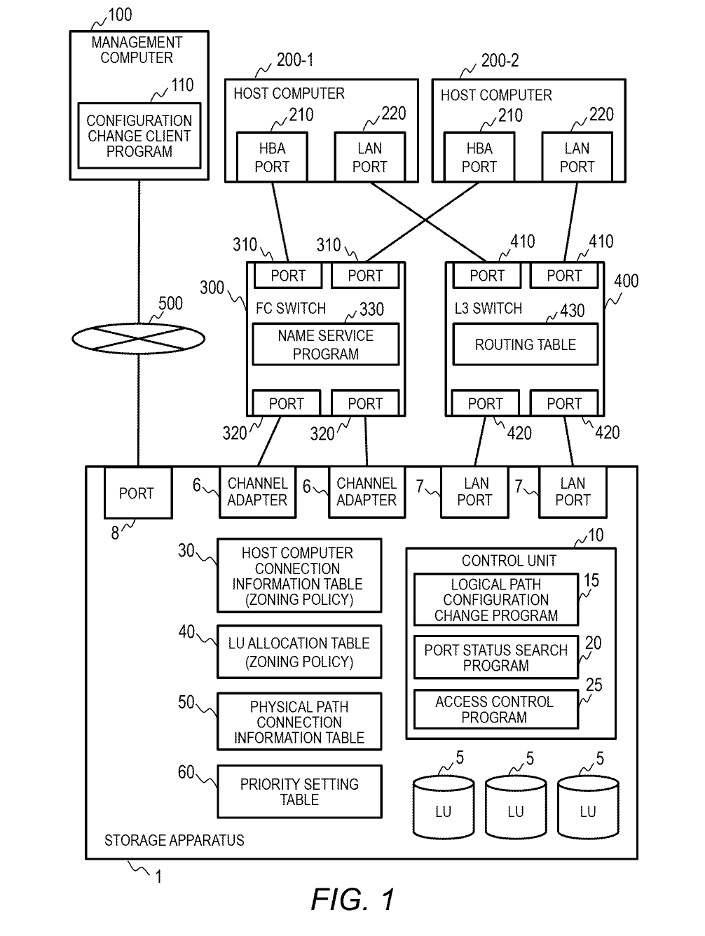

FIG. 1 is a block diagram illustrating one example of the storage system to which the present invention is applied. The storage system includes a storage apparatus 1 that provides the LU5 (volume) to host computers 200-1 and 200-2, the host computers 200-1 and 200-2 that access the LU5 of the storage apparatus 1, an FC (Fibre Channel) switch 300 connecting the host computers 200-1 and 200-2 to the storage apparatus 1, an L3 (Layer3) switch 400 connecting the host computers 200-1 and 200-2 to the storage apparatus 1, and a management computer 100 that manages the configuration of the LU5 of the storage apparatus 1 for example via a management network 500.

In the following description, when the description applies to both of the host computers 200-1 and 200-2, the host computers 200-1 and 200-2 will be simply denoted as host computers 200 not including the numbers subsequent to “-”. The host computers 200-1 and 200-2 have a similar configuration. In this embodiment, two types of the FC switch 300 and the L3 switch 400 are used as SAN. However, any of the FC switch 300 and the L3 switch 400 also may be used.

The host computer 200 is connected to the port 310 of the FC switch 300 via an HBA port 210 (the first interface). The FC switch 300 is connected to the channel adapter 6 of the storage apparatus 1 via a port 320.

The FC switch 300 includes a name service program 330 operated to store therein the information for connected devices and apparatuses (e.g., WWN: World Wide Name) to provide the information to the respective devices. The FC switch 300 also has a monitoring program (not shown) that sends, when any configuration change such as an addition or deletion of a connected device occurs, a status change notification to a predetermined device or apparatus.

The host computer 200 is connected to the port 410 of the L3 switch 400 via a LAN (Local Area Network) port 220 (the first interface). The L3 switch 400 is connected to the LAN port 7 of the storage apparatus 1 via the port 420. The L3 switch 400 manages a routing table 430 that stores the information for the connected devices or apparatuses (e.g., IP addresses) and that provides the information to the respective devices.

The management computer 100 executes a configuration change client program 110 to manage the configuration of the storage apparatus 1 to thereby manage the zoning of the storage system and the configurations of storage areas for example.

The storage apparatus 1 includes a port 8 connected to the management computer 100 via the management network 500, the channel adapter 6 (the second interface) connected to the FC switch 300, the LAN port 7 (the second interface) connected to the L3 switch 400, and the LU5.

The storage apparatus 1 is configured so that a control unit 10 operates to control the LU5 based on the access from a host computer 200 and a management request from the management computer 100.

The control unit 10 includes a logical path configuration change program 15 that manages the access path between the host computer 200 and the storage apparatus 1 and the LU5 allocation, a port status search program 20 that monitors the connection destination of the channel adapter 6 and the LAN port 7, and an access control program 25 that receives a SCSI command (e.g., a read request or a write request) from the host computer 200 to access the LU5.

The storage apparatus 1 includes, as data used by the respective programs, a host computer connection information table 30, an LU allocation table 40, a physical path connection information table 50, and a priority setting table 60. The host computer connection information table 30 (host computer connection information) and the LU allocation table 40 (storage area allocation information) are used as a zoning policy.

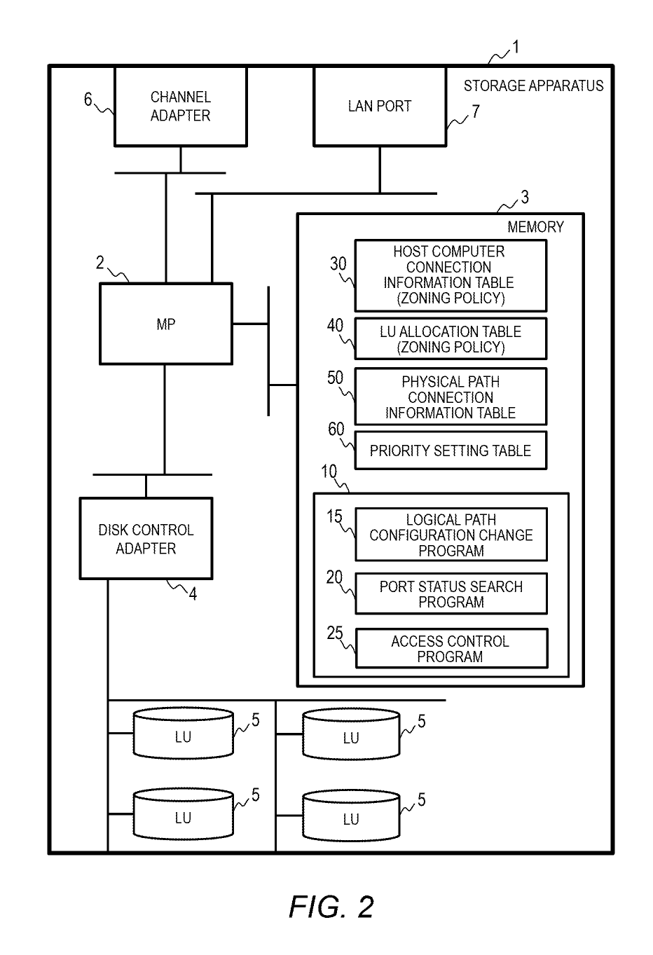

FIG. 2 is a block diagram illustrating one example of the configuration of the storage apparatus 1. The storage apparatus 1 includes a processor 2 (shown as an MP in the drawing) that performs a computing processing, a memory 3 that stores a program or data, a disk control adapter 4 that controls the access or configuration of the LU5, the channel adapter 6 connected to the FC switch 300, and the LAN port 7 connected to the L3 switch 400.

The logical path configuration change program 15, the port status search program 20, and the access control program 25 are loaded in the memory 3 and are executed by the processor 2 to function as the control unit 10. The memory 3 stores therein the host computer connection information table 30, the LU allocation table 40, the physical path connection information table 50, and the priority setting table 60 used by the respective programs.

The processor 2 operates as a function unit to provide a predetermined function by performing a processing based on a program of each function. For example, the processor 2 functions as a logical path configuration change unit that performs a processing based on the logical path configuration change program 15 and functions as an access control unit by performing a processing based on the access control program 25. Other programs are also may be used. The processor 2 also functions as a function unit that provides the respective functions of a plurality of processings executed by the respective programs. The computer and the computer system are an apparatus and a system including these function units.

The LU5 is a logical storage area allocated with a storage area such as a RAID array having a plurality of storage media (not shown) (e.g., drives). The storage apparatus 1 provides a LUN (storage area identifier) identifying the LU5 to the host computer 200.

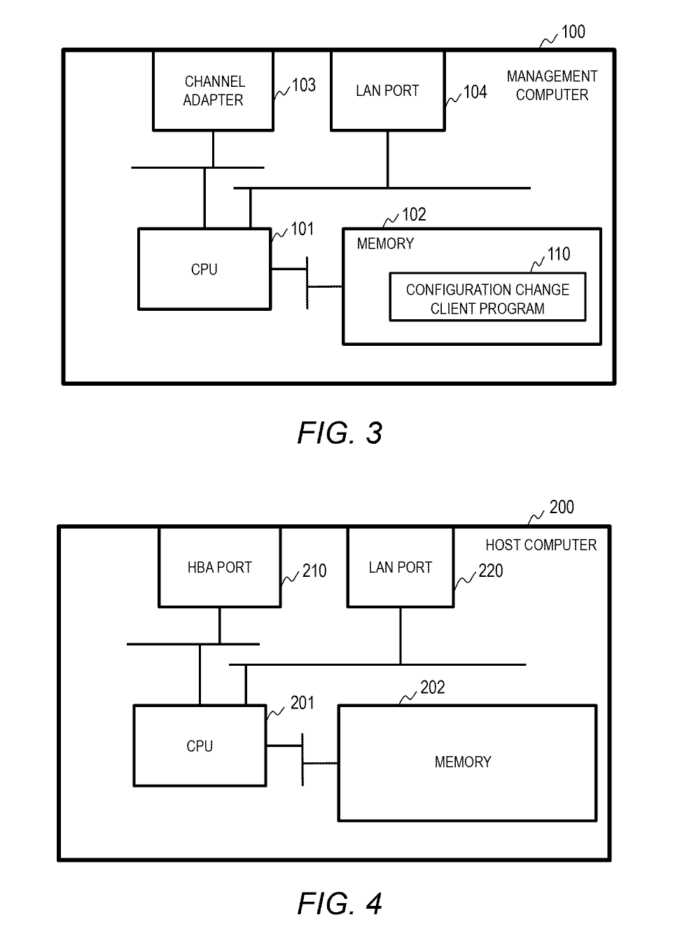

FIG. 3 is a block diagram illustrating one example of the configuration of the management computer 100. The management computer 100 includes a CPU 101 performing a computing processing, a memory 102 storing a program or data, a LAN port 104 connected to the management network 500, and a channel adapter 103.

The configuration change client program 110 is loaded to the memory 102 and is executed by the CPU 101. The management computer 100 may include a management program operated to manage the FC switch 300 or the L3 switch 400.

FIG. 4 is a block diagram illustrating one example of the configuration of the host computer 200. The host computer 200 includes a CPU 201 performing a computing processing, a memory 202 storing therein program or data, the HBA port 210 connected to the FC switch 300, and a LAN port 220 connected to the L3 switch 400. An OS (not shown) and an application accessing the LU5 are loaded in the memory 102 and are executed by the CPU 201.

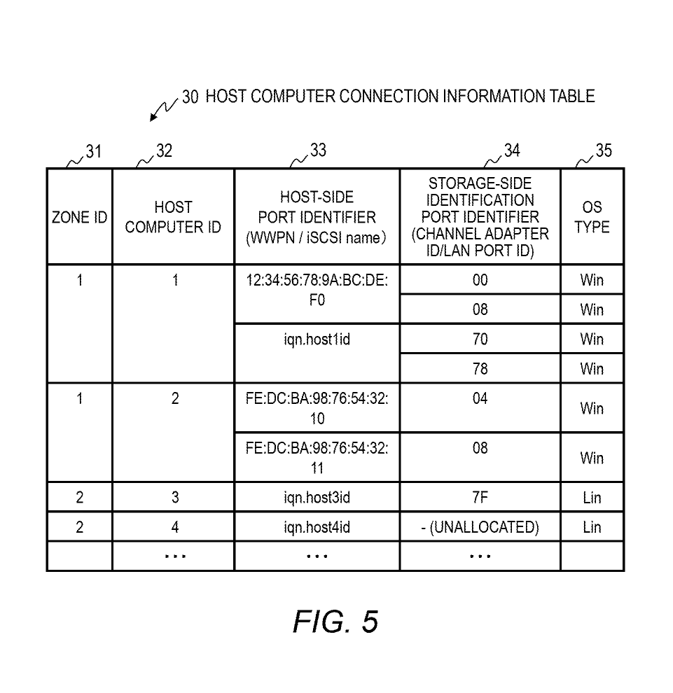

FIG. 5 illustrates one example of the host computer connection information table 30 constituting the zoning policy. The host computer connection information table 30 is generated based on an instruction from the management computer 100.

The host computer connection information table 30 includes, in one entry, a zone ID31, a host computer ID 32, a host-side port identifier 33 (the first port identifier), a storage-side port identifier 34 (the second port identifier), and an OS type 35.

The zone ID31 stores therein an identifier for the zoning in the storage system. The host computer ID 32 stores therein an identifier for each host computer 200. The host computer ID is an identifier given for each host computer 200.

The host-side port identifier 33 stores therein the HBA port 210 of the host computer 200 and the identifier of the LAN port 220. The host-side port identifier 33 stores therein a WWPN (World Wide Port Name) for the HBA port 210 of the host computer 200 and stores therein an iSCSI name for the LAN port 220 of the host computer 200.

The storage-side port identifier 34 stores therein the identifier of the channel adapter 6 or the identifier of the LAN port 7. The OS type 35 stores therein the type of the OS executed by the host computer 200.

The host computer connection information table 30 can acquire the identification of the host computer 200 belonging to the zone ID31 and the connection between the storage apparatus 1 and the host computer 200 from the host-side port identifier 33 and the storage-side port identifier 34. The above respective identifiers may be at least unique within the storage system.

The response pattern from the storage apparatus 1 for example is different depending on the OS type of the host computer 200. Thus, The OS type 35 can smoothly communicate with the host computer 200 based on the identified OS type.

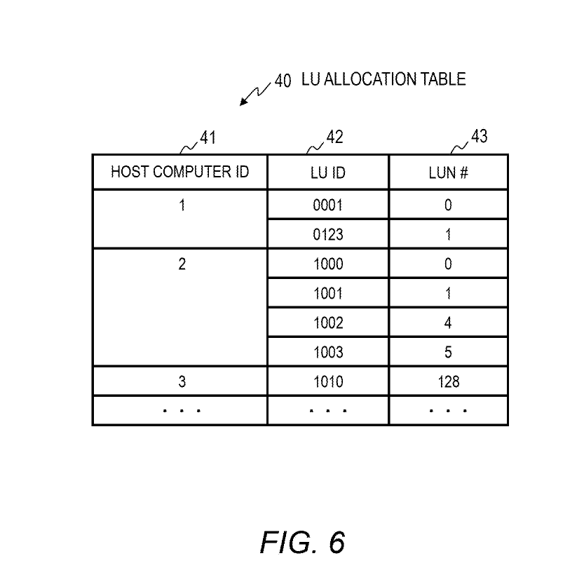

FIG. 6 illustrates one example of the LU allocation table 40 constituting the zoning policy. The LU allocation table 40 manages the LU5 allocated by the storage apparatus 1 to the host computer 200 based on the instruction from the management computer 100.

The LU allocation table 40 includes, in one entry, a host computer ID 41 storing the identifier of the host computer 200, an LU ID 42 storing therein the identifier of the LU5, and LUN#43 for allowing the host computer 200 to identify the LU5.

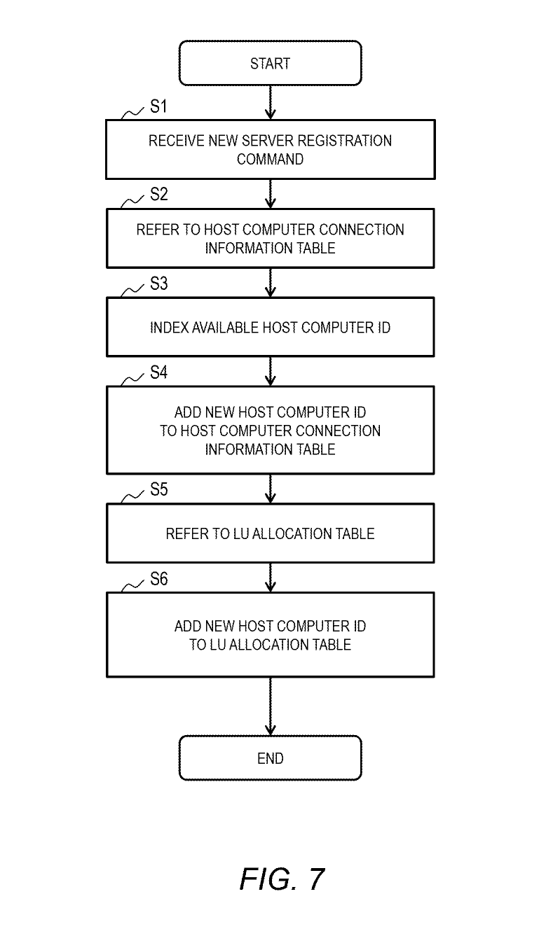

Next, the flowcharts of FIG. 7 to FIG. 10 show the processing when the storage apparatus 1 in the management computer 100 receives a new registration command of a new host computer 200, an allocation command of a new HBA port 210, a command to allocate the LU5 to the host computer 200, and an SCSI command in this order.

FIG. 7 is a flowchart illustrating one example of the processing to register the host computer 200 performed by the logical path configuration change program 15 of the storage apparatus 1. This processing is performed when a new registration command is received from the management computer 100. In the following description, the program performs the processing. However, the processor 2 or the storage apparatus 1 also may perform the processing.

First, the logical path configuration change program 15 receives the new registration command of the host computer 200 from the management computer 100 (S1). The new registration command specifies the zone ID and the host computer 200 to be registered.

The zone ID also may be determined by the logical path configuration change program 15. In this case, the logical path configuration change program 15 can allocate the available zone ID31 from the host computer connection information table 30 constituting the zoning policy to the to-be-newly-registered host computer 200.

Next, the logical path configuration change program 15 refers to the host computer connection information table 30 (S2) and acquires an available (or unused) host computer ID 32 (S3). The logical path configuration change program 15 adds a new entry to the host computer connection information table 30 to set the zone ID31 and the host computer ID 32 acquired as described above (S4).

Next, the logical path configuration change program 15 refers to the LU allocation table 40 constituting the zoning policy (S5) and adds a new entry to set the host computer ID 32 to the host computer ID 41.

By the above processing, the host computer connection information table 30 receives the zone ID31 of the newly-added host computer 200 and the host computer ID 32. The LU allocation table 40 receives the host computer ID 41 of the newly-added host computer 200.

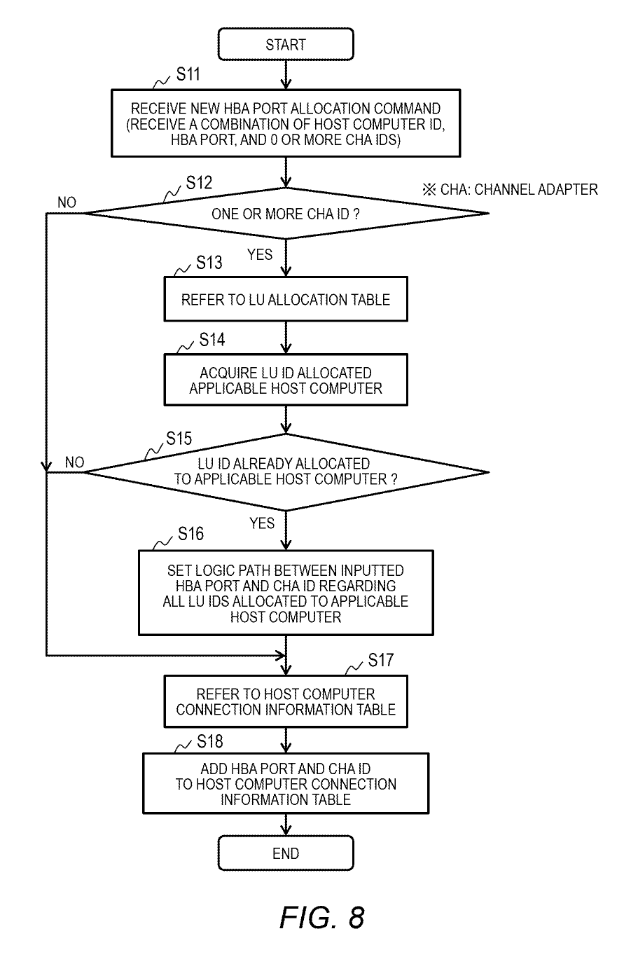

FIG. 8 is a flowchart illustrating one example of the processing performed by the logical path configuration change program 15 of the storage apparatus 1 to allocate the HBA port 210 of the host computer 200. This processing is executed when the allocation command of the new HBA port 210 is received from the management computer 100.

The logical path configuration change program 15 receives the allocation command for the newly-allocated HBA port 210 (S11). The allocation command for the HBA port 210 includes the ID of the host computer 200 (the host computer ID 32), the identifier of the HBA port 210, and 0 or more port identifier(s) of the channel adapter 6. When the number of the port identifier of the channel adapter 6 is 0, the management computer 100 does not specify the port of the channel adapter 6 and requests that the storage apparatus 1 automatically allocates the port of the channel adapter 6. The ID of the host computer 200 also may be the host computer ID 32 given by the storage apparatus 1 in the processing of FIG. 7.

In Step S12, the logical path configuration change program 15 determines whether the channel adapter 6 has one or more identifiers. When the channel adapter 6 has one or more identifiers, the processing proceeds to Step S13 in order to allocate the specified channel adapter 6. When the channel adapter 6 has 0 identifier, the logical path configuration change program 15 proceeds to Step S17 to automatically allocate the channel adapter 6.

The logical path configuration change program 15 refers to the LU allocation table 40 (S13) to acquire the ID 42 of the LU5 allocated to the host computer 200 (S14). The logical path configuration change program 15 determines whether the LU5 is already allocated to the host computer 200 (S15).

When the LU5 is already allocated to the host computer 200, the logical path configuration change program 15 proceeds to Step S16. When the LU5 is not yet allocated to the host computer 200, the logical path configuration change program 15 proceeds to Step S17.

In Step S16, the logical path configuration change program 15 sets, regarding all LU IDs 42 allocated to the host computer 200, a logical path (access path) between the HBA port 210 specified by the allocation command of the HBA port 210 and the channel adapter 6 having the specified identifier.

Next, the logical path configuration change program 15 refers to the host computer connection information table 30 (S17) to store, in the entry of the host computer ID 32 corresponding to the host computer 200 of the host computer connection information table 30, the identifier of the HBA port 210 in the host-side port identifier 33 to set the port identifier of the channel adapter 6 to the storage-side port identifier 34.

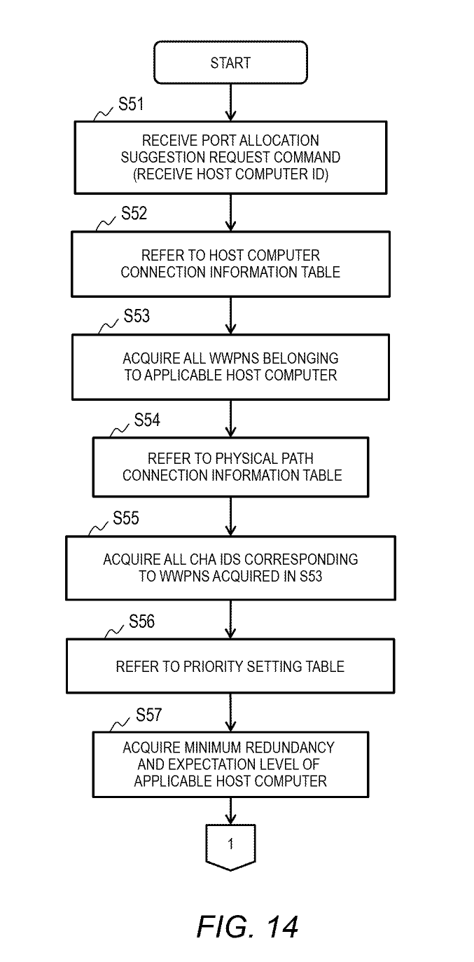

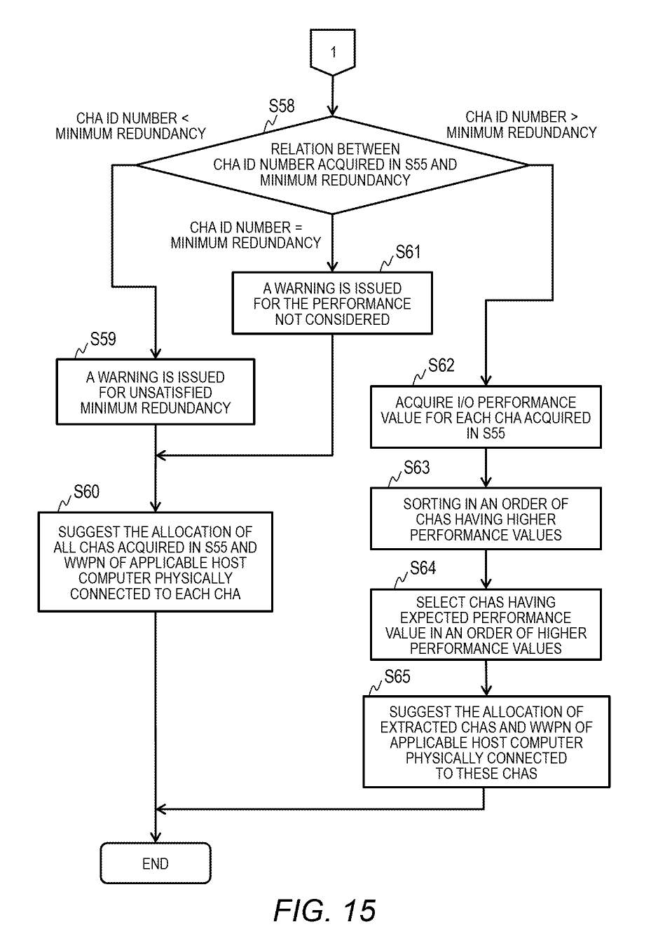

In Step S18, when Step S12 determines that the channel adapter 6 has 0 port identifier or when Step S15 determines that the ID of the LU5 is already allocated, the logical path configuration change program 15 may allocate the port identifier of the available channel adapter 6 to the specified HBA port 210 to set the port identifier of the available channel adapter 6 to the host computer connection information table 30. The processing to allocate the port of the channel adapter 6 to the HBA port 210 of the host computer 200 also may be the processings of FIG. 14 and FIG. 15.

In FIG. 8, an example is shown in which the HBA port 210 is newly allocated to the port of the channel adapter 6. However, the processing similar to the above one also may be performed to newly allocate the LAN port 220 to the LAN port.

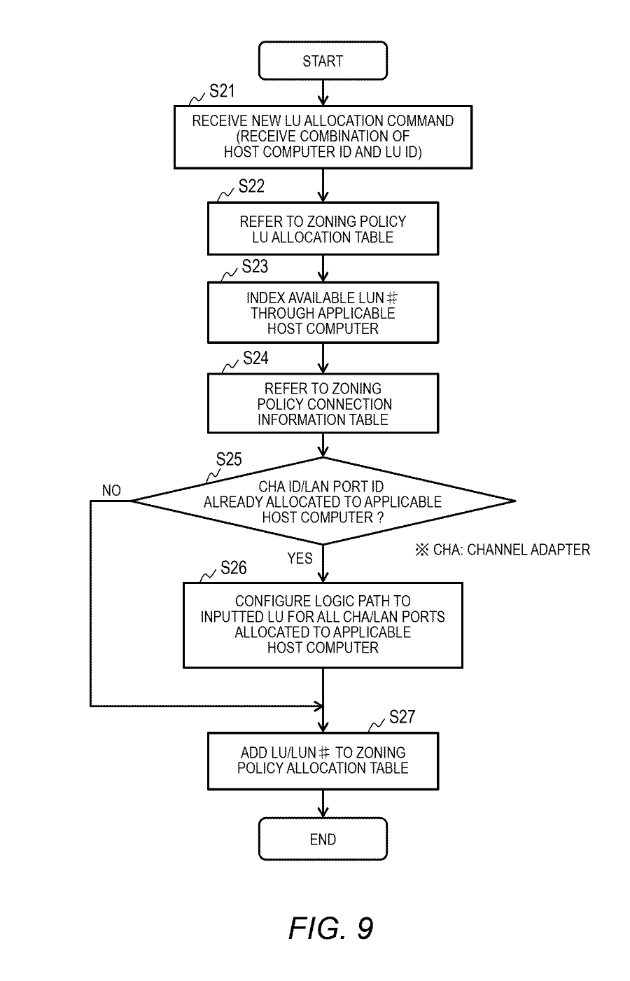

FIG. 9 is a flowchart illustrating one example of the processing performed by the logical path configuration change program 15 of the storage apparatus 1 to allocate the new LU5 to the host computer 200. This processing is executed when the allocation command for the new LU5 is received from the management computer 100.

First, the logical path configuration change program 15 receives the new LU allocation command from the management computer 100 (S21). The allocation command includes a combination of the host computer ID and the LU ID.

The logical path configuration change program 15 refers to the LU allocation table 40 (S22) and acquires the available (or not-yet-allocated) LUN#43 (S23). Next, the logical path configuration change program 15 refers to the host computer connection information table 30 (S24) and determines whether the port ID of the channel adapter 6 or the ID of the LAN port 7 is already allocated to the host computer 200 (S25).

When the port ID is already allocated, the logical path configuration change program 15 proceeds to Step S26. When the port ID is not yet allocated, the logical path configuration change program 15 proceeds to Step S27. In Step S26, the logical path configuration change program 15 sets, with regards to the port of the channel adapter 6 and the LAN port 7 allocated to the host computer 200, a logical path to the LU5 corresponding to LUN#43 (the LU ID 42).

In Step S27, the logical path configuration change program 15 sets the ID 42 of the LU5 and LUN#43 specified by a command in the LU allocation table 40, thereby completing the processing.

By the above processing, LUN#43 corresponding to the requested LU5 can be allocated to the host computer 200 to set a logical path to the port of the channel adapter 6 or the LAN port 7.

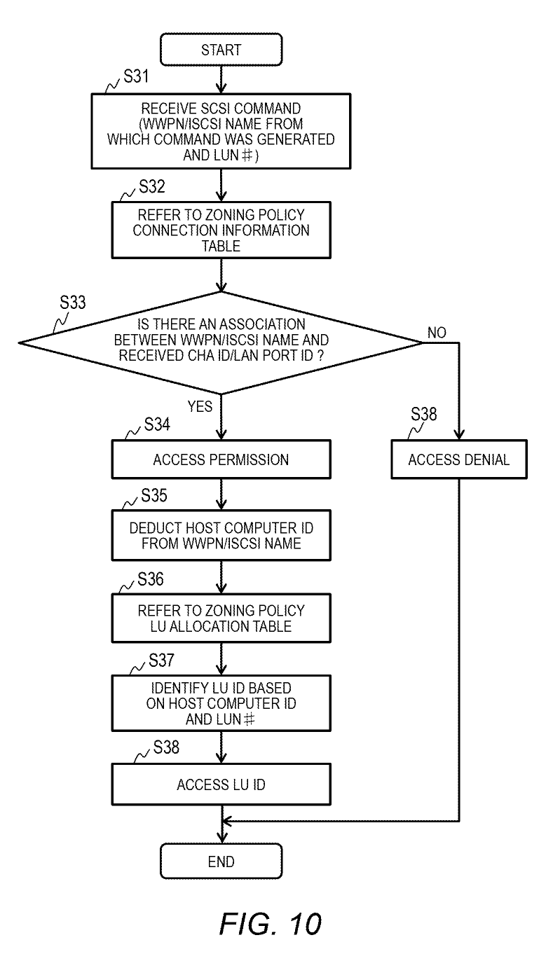

FIG. 10 is a flowchart illustrating one example of the processing performed by the access control program 25 of the storage apparatus 1. This processing is executed when the SCSI command is received from the host computer 200.

The access control program 25 accepts the information added based on the SCSI command and the SAN protocol (S31). The SCSI command includes specified target LUN and access. Information added with a SAN protocol can further include the WWPN or iSCSI name of an issuing source.

The access control program 25 refers to the host computer connection information table 30 (S32) to determine whether the received WWPN (or iSCSI name) is associated with the storage-side port identifier 34 (S33).

It is determined whether the received WWPN (or iSCSI name) is associated with the storage-side port identifier 34 (S33).

When the WWPN (or iSCSI name) is associated with storage-side port identifier 34, the access control program 25 proceeds to Step S34 to permit an access. When the WWPN (or iSCSI name) is not associated with storage-side port identifier 34, the access control program 25 proceeds to Step S38 to deny an access, thereby completing the processing.

In Step S34, the access control program 25 permits the access. In Step S35, the access control program 25 refers to the host computer connection information table 30 to acquire the host computer ID 32 from the WWPN (iSCSI name).

Next, the access control program 25 refers to the LU allocation table 40 (S36) to identify the to-be-accessed LU ID 42 based on the host computer ID 32 and the LUN (S37). The access control program 25 executes the specified access based on the command received with regard to the identified LU ID 42 (S38).

Through the above processing, the storage apparatus 1 can determine whether the access should be permitted or not based on the WWPN (iSCSI name) to apply the zoning policy.

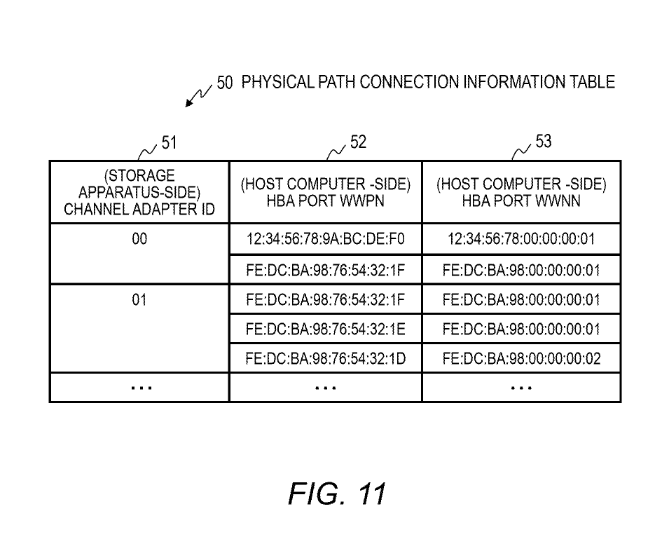

FIG. 11 illustrates one example of the physical path connection information table 50. This physical path connection information table 50 is generated and updated as described later by the port status search program 20.

The physical path connection information table 50 includes, in one entry, a channel adapter ID51 to store the identifier of the channel adapter 6 of the storage apparatus 1, an HBA port WWPN 52 to store the WWPN of the HBA port 210 of the host computer 200, and an HBA port WWNN 53 to store the WWNN (World Wide Node Name) of the HBA port 210 of the host computer 200.

The WWNN is an identifier given to each HBA. The WWPN is an identifier given to each HBA port 210. Thus, the WWPNs having the same WWNN securely mean that these WWPNs both belong to the same host computer.

Thus, the logical path configuration change program 15 is configured, when the HBA port 210 of the host computer 200 is allocated to a port of the channel adapter 6, to refer to the physical path connection information table 50 to suggest that the HBA port WWPNs 52 having the same HBA port WWNN 53 may belong to the same host computer 200.

However, the HBA port WWPNs 52 having different HBA port WWNNs 53 do not always mean that these HBA port WWPNs 52 belong to different host computer 200. Thus, the storage apparatus 1 can suggest the connection status of the HBA port 210 to the manager of the storage system for example in a detailed unit.

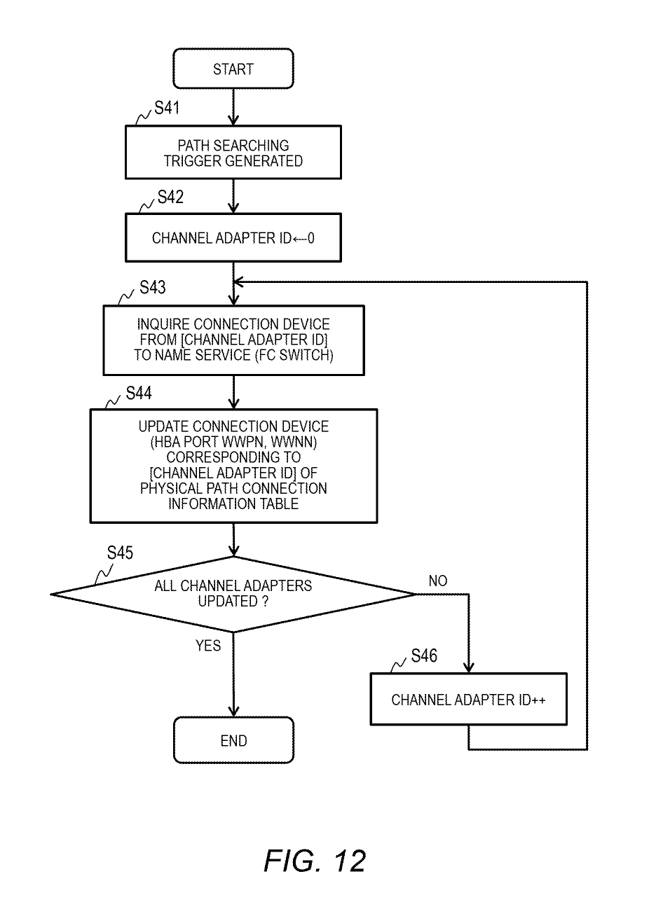

FIG. 12 is a flowchart illustrating one example of the processing performed in the port status search program 20 of the storage apparatus 1. When a predetermined trigger is triggered, the storage apparatus 1 starts a processing to search the physical path connection status.

The port status search program 20 starts the processing when the predetermined trigger is triggered (S41). The predetermined trigger includes, for example, a timing at which a predetermined command is received from the management computer 100, a timing at which the WWN has a new login, and a timing at which a status change notification is received from the FC switch 300.

The port status search program 20 sets “0” to the identifier of the channel adapter 6 to subsequently start the processing (S42). The port status search program 20 inquires a connected device from the channel adapter 6 having the set identifier to a name service of the FC switch 300 (name service program 330) (S43).

The port status search program 20 receives the response from the name service of the FC switch 300 from the channel adapter 6 to update the HBA port WWPN 52 and the HBA port WWNN 53 corresponding to the identifier of the channel adapter 6 (or to generate a new entry) (S44).

The port status search program 20 determines whether the above processing is executed for all of the channel adapters 6 belonging to the storage apparatus 1 (S45). When the above processing is completed for all of the channel adapters 6, the processing is completed. When there is any channel adapter 6 for which the processing is not yet completed on the other hand, the processing proceeds to Step S46 to increment the value of the identifier of the channel adapter 6. Then, the processing returns to Step S43 to repeat the processing.

The above processing can provide the identification of a path that can be physically accessed from the channel adapter 6 (the host computer 200 and HBA port) and the update of the physical path connection information table 50. In the above description, an example was shown in which a path that can be physically accessed from the channel adapter 6 was searched. However, the physical path connection information table 50 also can be generated for the LAN port 7 by acquiring the routing table 430 of the L3 switch 400.

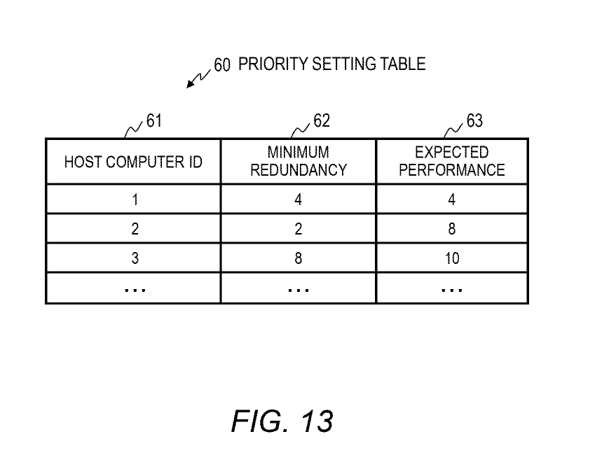

FIG. 13 illustrates one example of the priority setting table 60. This priority setting table 60 is generated and updated by the logical path configuration change program 15.

The priority setting table 60 includes, in one entry, a host computer ID 61 to store the identifier of the host computer 200, a minimum redundancy 62 to store a value (minimum value) of a path required to secure the redundancy, and an expected performance 63 to store the priority (expected performance value) used to allow the host computer 200 accesses the storage apparatus 1.

The minimum redundancy 62 and the expected performance 63 can include a new registration command of the host computer 200, an allocation command of the HBA port 210, or a command to allocate the LU5 to the host computer 200 and stores therein a value received from the host computer 200.

The expected performance 63 includes the number of physical paths (parallel degree) set as the priority of the host computer 200. Alternatively, any value also may be used that correspond to an indicator showing the performance of the storage apparatus 1 such as the IOPS (the number of I/O access per one second), a band, or an I/O response time.

FIG. 14 and FIG. 15 are flowcharts showing one example of the processing to suggest the port allocation. This processing is executed by the logical path configuration change program 15 when a command for the port allocation suggestion request is received from the management computer 100. The execution of this processing requires an assumption that the host computer ID 32 and the host-side port identifier 33 are registered in the host computer connection information table 30 and the priority setting table 60 is already set.

First, the logical path configuration change program 15 receives the command for the port allocation suggestion request (S51). The command for the port allocation suggestion request includes the ID of the host computer 200.

The logical path configuration change program 15 refers to the host computer connection information table 30 (S52) to acquire all of the host-side port identifiers 33 (WWPNs or iSCSI names) belonging to the ID of the host computer 200 included in the command (S53).

Next, the logical path configuration change program 15 refers to the physical path connection information table 50 (S54) to acquire all of the channel adapters ID51 corresponding to the host-side port identifiers 33 (WWPN) acquired in the above Step S53 (S55).

The logical path configuration change program 15 refers to the priority setting table 60 (S56) to acquire the minimum redundancy 62 and the expected performance 63 from the host computer ID 61 of the specified host computer 200 (S57).

Next, in Step S58 of FIG. 15, the logical path configuration change program 15 is branched depending on the result of comparing the number of the channel adapters ID51 acquired in the above Step S55 with the minimum redundancy 62 acquired in Step S57.

When the number of the channel adapters ID51 is smaller than the minimum redundancy 62, the logical path configuration change program 15 proceeds to Step S59 to send, to the management computer 100, a warning that the minimum redundancy 62 cannot be satisfied.

When the number of the channel adapters ID51 is equal to the minimum redundancy 62, then the logical path configuration change program 15 proceeds to Step S61 to send, to the management computer 100, a warning that the expected performance 63 cannot be taken into consideration.

After the processings of Steps S59 and S61, the logical path configuration change program 15 proceeds to Step S60. In Step S60, the logical path configuration change program 15 suggests to allocate, to all of the channel adapters ID51 acquired in Step S55, the WWPNs of the host computers 200 physically connected to the respective channel adapters 6 including the channel adapter ID51, thereby completing the suggestion of the allocation of the ports to the management computer 100.

When the number of the channel adapters ID51 exceeds the minimum redundancy 62 on the other hand, the logical path configuration change program 15 proceeds to Step S62 to acquire the current I/O performance value for the channel adapter ID51 acquired in Step S55. The ports of the channel adapter 6 may be shared among a plurality of host computers 200 in a time division manner. Thus, the current I/O performance value can provide the estimation showing at what level the ports are used by other host computers 200.

The logical path configuration change program 15 sorts the channel adapters ID51 in a descending order of I/O performance values (S63). Then, the logical path configuration change program 15 selects those channel adapters ID51 in a range from the one at the top of the order to the one having the value of the expected performance 63 (S64). Specifically, the channel adapters ID51 are selected in a descending order of the I/O performances based on the parallel degree specified by the expected performance 63.

The logical path configuration change program 15 suggests the allocation of the selected channel adapter ID51 and the WWPN of the host computer 200 physically connected to the channel adapter 6 including the channel adapter ID51 (S65).

By the above processing, the ID of the host computer 200 is specified and the suggestion of the port allocation is requested. This allows the storage apparatus 1 to suggest, depending on the current use status of the port of the channel adapter 6, the HBA port (WWPN) of the host computer 200 allocated to the identifier of the channel adapter 6 (i.e., a logical path).

The above description showed an example in which the port allocation suggestion was requested with regard to the HBA port 210 and the channel adapter 6.

However, the iSCSI name of the host computer 200 and the ID of the LAN port 7 also can be subjected to the processing similar to the above one to allow the logical path configuration change program 15 to suggest the port allocation (logical path).

The logical path configuration change program 15 can suggest the logical path performance in consideration of the performance of the ports used by other host computers 200 for example. The logical path configuration change program 15 also can be configured to use, when a host computer 200 has a high priority (or high minimum redundancy 62 or expected performance 63) in the priority setting table 60, all connectable logical paths and to allocate only one logical path when a host computer 200 has a low priority.

In the above processing, an example was shown in which the logical path configuration change program 15 suggests a logical path. However, the logical path configuration change program 15 also may set the suggested logical path. This can allow the logical path depending on the priority setting table 60 to be automatically generated by merely setting the ID of the host computer 200.

In the above processing, an example was shown in which the logical path configuration change program 15 suggests a logical path by specifying the host computer 200. However, another configuration also can be used in which the LUN is allocated to the suggested logical path by specifying the ID of the host computer 200 and the LUN of the storage apparatus 1. This allows a logical path depending on the priority setting table 60 to be automatically generated by merely specifying the ID of the host computer 200 and the LUN of the storage apparatus 1 to allocate the LUN.

As described above, according to this embodiment, the host computer connection information table 30 for setting the zoning policy provides the integrated control of resources to which the access is permitted such that the control is performed mainly based on the IDs of the host computers 200. This eliminates the need for the manager of the storage system using the management computer 100 to know the complicated relation among resources in the storage system. Thus, a required change can be automatically and uniformly applied to all related resources by merely specifying the host computer 200 to perform the configuration change. Thus, the labor required to manage access paths can be significantly reduced while assuring the access control required for the storage apparatus 1.

Furthermore, the invention is not limited to a configuration change and also can be applied to a setting change where the port setting is required such as when the OS of the host computer 200 or iSCSI authorization information is changed by allowing the manager to specify the host computer 200.

Thus, in contrast with the prior art, the manager does not have to set a zoning policy for each port of the storage system. Furthermore, when a configuration change (e.g., a LU change) occurs, the manager also does not have to find all zoning policies including the applicable HBA ports to appropriately edit all of these zoning policies.

Therefore, this embodiment provides easy setting and management of the zoning, provides simpler setting and management of the connection between ports, provides an autonomous port setting, and also can support the structuring of the logical path required for the host computers 200.

In the above embodiment, an example was shown in which the HBA port 210, the LAN port 7, the port of the channel adapter 6, and the LAN port 7 were used as an interface for the host computer 200 to access the storage apparatus 1. However, the interface is not limited to the HBA and NIC and any interface may be used that can provide an access to the SAN.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

What is claimed is:

1. A storage apparatus including a processor, a memory, and a storage medium, comprising:
a control unit for managing a storage area allocated from the storage medium to a host computer,
wherein the control unit is configured:
to give an identifier to a host computer accessing the storage area,
to receive a first port identifier of a first interface of the host computer accessing the storage area,
to allocate, to the first port identifier of the first interface, a second port identifier of a second interface of the storage apparatus communicating with the host computer to set a logical path to associate the identifier of the host computer with the first port identifier and the second port identifier to store the identifier of the host computer in host computer connection information,
to allocate the identifier of the storage area to the identifier of the host computer to associate the identifier of the host computer with the identifier of the storage area to store the identifier of the host computer in storage area allocation information, and
to refer, upon receiving an access to the storage area from the host computer, to the host computer connection information and the storage area allocation information to control the access.

2. The storage apparatus according to claim 1, wherein:
the control unit is configured:
to receive the identifier of the host computer and priority information including redundancy to set the logical path depending on the redundancy.

3. The storage apparatus according to claim 1, wherein:
the control unit is configured:
to receive the identifier of the host computer and priority information including a performance to set the logical path depending on the performance.

4. The storage apparatus according to claim 1, wherein:
the control unit is configured:
to detect the first port identifier connected to the second interface to associate the identifier of the second interface with the first port identifier to store the identifier of the second interface in physical path connection information, and
to receive the identifier of the host computer to output, based on the host computer connection information and the physical path connection information, the first port identifier physically connected to the second interface for which a logical path can be set.

5. The storage apparatus according to claim 1, wherein:
the control unit is configured:
to detect the first port identifier connected to the second interface to associate the identifier of the second interface with the first port identifier to store the identifier of the second interface in physical path connection information, and
to receive the identifier of the host computer and the identifier of the storage area to set, based on the host computer connection information and the physical path connection information, a logical path for the first port identifier physically connected to the second interface to allocate the identifier of the storage area to the second interface.

6. A storage system, comprising:
a storage apparatus including a processor, a memory, and a storage medium;
a host computer for accessing a storage area of the storage medium via a network; and
a management computer for managing the storage apparatus via the network,
wherein the storage apparatus has:
a control unit for managing a storage area allocated from the storage medium to the host computer,
the control unit is configured:
to give an identifier to the host computer accessing the storage area based on a request from the management computer,
to receive a first port identifier of a first interface of the host computer accessing the storage area from the host computer,
to allocate a second port identifier of a second interface of the storage apparatus communicating with the host computer to the first port identifier of a first interface to set a logical path to associate the identifier of the host computer with the first port identifier and the second port identifier to store the identifier of the host computer in host computer connection information,
to allocate the identifier of the storage area to the identifier of the host computer to associate the identifier of the host computer with the identifier of the storage area to store the identifier of the host computer in storage area allocation information, and
to refer, when receiving an access to the storage area from the host computer, to the host computer connection information and the storage area allocation information to control the access.

7. The storage system according to claim 6, wherein:
the control unit is configured:
to receive the identifier of the host computer and priority information including redundancy from the management computer to set the logical path depending on the redundancy.

8. The storage system according to claim 6, wherein:
the control unit is configured:
to receive the identifier of the host computer and priority information including a performance from the management computer to set the logical path depending on the performance.

9. The storage system according to claim 6, wherein:
the control unit is configured:
to detect the first port identifier connected to the second interface to associate the identifier of the second interface with the first port identifier to store the identifier of the second interface in physical path connection information, and
to receive the identifier of the host computer from the management computer to output, based on the host computer connection information and the physical path connection information and to the management computer, the first port identifier physically connected to the second interface for which a logical path can be set.

10. The storage system according to claim 6, wherein:
the control unit is configured:
to detect the first port identifier connected to the second interface to associate the identifier of the second interface with the first port identifier to store the identifier of the second interface in physical path connection information, and
to receive the identifier of the host computer and the identifier of the storage area from the management computer to set, based on the host computer connection information and the physical path connection information, a logical path for the first port identifier physically connected to the second interface to allocate the identifier of the storage area to the second interface.

11. A storage apparatus management method including a processor, a memory, and a storage medium, the method manages a storage area allocated from the storage medium to a host computer, comprising:
a first step of allowing the storage apparatus to give an identifier to a host computer accessing the storage area;
a second step of allowing the storage apparatus to receive a first port identifier of a first interface of the host computer accessing the storage area;
a third step of allowing the storage apparatus to allocate a second port identifier of a second interface of the storage apparatus communicating with the host computer to the first port identifier of the first interface to set a logical path to associate the identifier of the host computer with the first port identifier and the second port identifier to store the identifier of the host computer in host computer connection information;
a fourth step of allowing the storage apparatus to allocate the identifier of the storage area to the identifier of the host computer to associate the identifier of the host computer with the identifier of the storage area to store the identifier of the host computer in storage area allocation information; and
a fifth step of referring, when the storage apparatus receives an access to the storage area from the host computer, to the host computer connection information and the storage area allocation information to control the access.

12. The storage apparatus management method according to claim 11, wherein:
the fourth step is configured:
to receive the identifier of the host computer and priority information including redundancy to set the logical path depending on the redundancy.

13. The storage apparatus management method according to claim 11, wherein:
the fourth step is configured:
to receive the identifier of the host computer and priority information including a performance to set the logical path depending on the performance.

14. The storage apparatus management method according to claim 11, further comprising:
a sixth step of allowing the storage apparatus to detect the first port identifier connected to the second interface to associate the identifier of the second interface with the first port identifier to store the identifier of the second interface in physical path connection information; and
a seventh step of allowing the storage apparatus to receive the identifier of the host computer to output, based on the host computer connection information and the physical path connection information, the first port identifier physically connected to the second interface for which a logical path can be set.

15. The storage apparatus management method according to claim 11, wherein: further comprising:
a sixth step of allowing the storage apparatus to detect the first port identifier connected to the second interface to associate the identifier of the second interface with the first port identifier to store the identifier of the second interface in physical path connection information; and
an eighth step of allowing the storage apparatus to receive the identifier of the host computer and the identifier of the storage area to set, based on the host computer connection information and the physical path connection information, a logical path to the first port identifier physically connected to the second interface to allocate the identifier of the storage area to the second interface.
